(19) United States
(12) Patent Application Publication
(10) Pub. No.: US 2025/0150161 A1
(43) Pub. Date: May 8, 2025

(54) METHOD FOR CONTROLLING A SATELLITE CAPABLE OF EXCHANGING DATA WITH A PLURALITY OF VEHICLES

(71) Applicant: Continental Automotive Technologies GmbH, Hannover (DE)

(72) Inventors: Emmanuel PASQUET, Frouzins (FR); Mohamed CHEIKH, Toulouse (FR); Sébastien KESSLER, Drémil - lafage (FR)

(73) Assignee: Continental Automotive Technologies GmbH, Hannover (DE)

(21) Appl. No.: 18/838,026

(22) PCT Filed: Apr. 28, 2023
(86) PCT No.: PCT/EP2023/061252

§ 371 Date: Aug. 13, 2024

(30) Foreign Application Priority Data
Apr. 28, 2022 (FR) 2204006

(51) Int. Cl. H04B 7/185; H04W 4/40

(52) U.S. Cl. CPC H04B 7/18513; H04B 7/18519; H04W 4/40

(57) ABSTRACT

A method for controlling a satellite configured to exchange data with a plurality of vehicles positioned in a visibility zone of the satellite. The method includes estimating a number of vehicles eligible for a specific service present in the visibility zone using a global data receiver module configured to receive data from all of the visibility zone; and activating, depending on the estimated number of vehicles eligible for the specific service in the visibility zone, the global data receiver module or all or some of the local data receiver modules, configured to receive data from a respective sub-zone of the visibility zone, for reception of data.

### CROSS REFERENCE TO RELATED APPLICATIONS

This application is the U.S. National Phase Application of PCT International Application No. PCT/EP2023/061252, filed Apr. 28, 2023, which claims priority to French Patent Application No. 2204006, filed Apr. 28, 2022, the contents of such applications being incorporated by reference herein.

### FIELD OF THE INVENTION

The present disclosure relates to the field of control of a satellite during exchange of data between this satellite and vehicles.

### BACKGROUND OF THE INVENTION

Transmission of data between satellites and vehicles is becoming increasingly prevalent with the emergence of autonomous vehicles, in which certain services are downloaded or updated via an exchange of data between satellite and vehicle.

In this case, a satellite intended to exchange with vehicles, for example an LEO satellite (LEO standing for Low Earth Orbit) of the CubeSat type or any other type of satellite, has a very large visibility zone of the order of hundreds of thousands of km². The visibility zone covered by the satellite may thus include several hundred thousand vehicles or several million vehicles with which the satellite is capable of exchanging data.

As regards reception of data by the satellite, because of the large number of vehicles in the visibility zone, a large number of messages may be received. However, the frequency resources allocated to the satellite are limited. Collisions between messages sent from the vehicles to the satellite may thus occur and interfere with correct accomplishment of the exchanges of data.

As regards transmission of data from the satellite to the vehicles, transmitting messages to a large number of vehicles requires the satellite to be able to draw on substantial energy resources, which ability is in particular dependent on the size of the battery of the solar panels of the satellite. Inexact management in the satellite of the power allocated to exchange of data with vehicles therefore leads to over-dimensioning of the battery and solar panels, this increasing the cost of the satellite and of its launch.

An aspect of the invention improves the situation.

### SUMMARY OF THE INVENTION

The present disclosure provides in this respect a method for controlling a satellite configured to exchange data with a plurality of vehicles positioned in a visibility zone of the satellite, the satellite comprising:
a global data transmitter module configured to transmit data to all of the visibility zone,
a global data receiver module configured to receive data from all of the visibility zone,
a plurality of local data transmitter modules, each local data transmitter module being configured to transmit data in a respective sub-zone of the visibility zone,
a plurality of local data receiver modules, each local data receiver module being configured to receive data from a respective sub-zone of the visibility zone,
   and the method comprising:
estimating a number of vehicles eligible for a specific service present in the visibility zone using the global data receiver module, and
activating, depending on the estimated number of vehicles eligible for the specific service in the visibility zone, the global data receiver module or all or some of the local data receiver modules for reception of data.

Optionally, the method comprises activating, depending on the estimated number of vehicles eligible for the specific service in the visibility zone, the global data transmitter module or all or some of the local data transmitter modules for transmission of data.

Optionally, the method comprises transmitting data from the satellite to the vehicles using the one or more activated transmitter modules.

Optionally, the method comprises deactivating, depending on the estimated number of vehicles eligible for the specific service in the visibility zone, the global transmitter module or all or some of the local transmitter modules for transmission of data.

Optionally, the method comprises receiving data from the vehicles using the one or more activated receiver modules.

Optionally, the method comprises deactivating, depending on the estimated number of vehicles eligible for the specific service in the visibility zone, the global receiver module or all or some of the local receiver modules for reception of data.

The present disclosure also relates to a method for controlling a satellite from a ground station in such a way that a satellite implements any of the control methods described in the present patent application.

According to another aspect, the present patent application relates to a computer program comprising instructions for implementing any of the methods described in the present patent application when this program is executed by a processor.

According to another aspect, the present application relates to a non-transient computer-readable storage medium storing code instructions for implementing any one of the methods described in the present document.

According to another aspect, the present disclosure relates to a device for activating/deactivating data transmitter and receiver modules of a satellite, the satellite comprising:
a global data transmitter module configured to transmit data to all of the visibility zone,
a global data receiver module configured to receive data from all of the visibility zone,
a plurality of local data transmitter modules, each local data transmitter module being configured to transmit data in a respective sub-zone of the visibility zone,
a plurality of local data receiver modules, each local data receiver module being configured to receive data from a respective sub-zone of the visibility zone,
   wherein the device is configured to:
activate, depending on an estimated number of vehicles eligible for the specific service in the visibility zone, the global data receiver module or all or some of the local data receiver modules for reception of data,
deactivate, depending on the estimated number of vehicles eligible for the specific service in the visibility zone, of the global data receiver module or all or some of the local data receiver modules for reception of data.

Optionally, the device is also configured to:
activate, depending on the estimated number of vehicles eligible for a specific service in the visibility zone, the global data transmitter module or all or some of the local data transmitter modules for transmission of data,
deactivate, depending on the estimated number of vehicles eligible for a specific service in the visibility zone, the global data transmitter module or all or some of the local data transmitter modules for transmission of data.

According to another aspect, the present disclosure relates to a satellite, for example a low-earth-orbit satellite, into which is embedded any of the activating/deactivating devices described in the present application.

The method for controlling a satellite and the device for activating/deactivating data transmitter and receiver modules of the satellite according to the present disclosure allow data transmitter and receiver modules of the satellite to be activated and deactivated depending on the estimated number of vehicles present in the zone that it is overflying and depending on the nature of the services to be provided to the vehicles present. The modules of the satellite are therefore activated and deactivated dynamically so that the power that they need to consume to operate is tailored to the number of vehicles present in the visibility zone of the satellite and to the nature of the services to be provided to these vehicles insofar as certain of these services require little data to be exchanged between the satellite and the vehicles. In other words, the method and device allow exact management of the satellite power allocated to the exchange of data with vehicles in the sense that the satellite consumes less power unnecessarily, in particular in visibility zones where there are no or very few vehicles or in zones where a large proportion of the vehicles present are associated with services the nature of which does not require large amounts of data to be exchanged. Therefore, the power drawn by the satellite to exchange data with the vehicles is reduced, this in particular potentially allowing the satellite to be equipped with a battery having a lower charging capacity while decreasing the surface area of the solar panels required to power it, thus reducing the cost of the satellite and of its launch.

Moreover, the ability to activate several local receiver modules for a given visibility zone allows collisions between the various messages transmitted by the vehicles to be reduced since a local receiver module receives only messages transmitted by vehicles in its respective sub-zone. These messages cannot therefore collide with other messages transmitted by vehicles present in the visibility zone but outside the sub-zone associated with the local receiver module.

The method and device according to the present disclosure therefore simultaneously reduce the cost of the satellite and of its launch and the collision risk engendered by the messages transmitted by the various vehicles in the visibility zone.

### BRIEF DESCRIPTION OF THE DRAWINGS

Other features, details and advantages will become apparent on reading the following detailed description, and on analyzing the appended drawings, in which:

FIG. 1 shows one example of an architecture for communication between a satellite and a plurality of vehicles.

FIG. 2 shows one example of an LEO satellite (LEO standing for Low-Earth Orbit).

FIG. 3 shows one example of a method for controlling a satellite.

FIG. 4 shows one example of a visibility zone and of visibility sub-zones associated with a global transmitter or receiver module and with local transmitter or receiver modules.

FIG. 5 shows one example of a transceiver-module architecture sharing the same antenna.

### DETAILED DESCRIPTION OF EXEMPLARY EMBODIMENTS

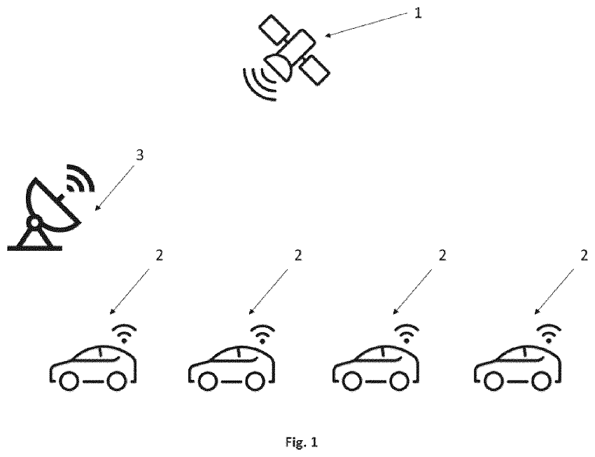

Reference will now be made to FIG. 1, which shows one example of a communication architecture in which the various methods presented in the present patent application may be implemented.

The shown example of a communication architecture comprises an LEO satellite 1 (LEO standing for Low-Earth Orbit) and a plurality of vehicles 2. The architecture may also comprise a ground station 3.

An LEO satellite must be understood in the present patent application to be a satellite operating in low-earth orbit, i.e. operating at an altitude of up to 2000 kilometers. An LEO satellite may for example correspond to a CubeSat satellite.

The plurality of vehicles 2 are located in a visibility zone of the LEO satellite. The visibility zone of the LEO satellite is defined as the portion of the Earth's surface within which the LEO satellite is able to exchange communication signals with various entities, for example with a view to transmitting or receiving data. In this case, an LEO satellite being in orbit around the Earth, the visibility zone that it covers represents an area on the ground of the order of 2700 to 1 000 000 km², and this zone moves with the movement of the satellite. The number of vehicles located in this zone and with which the satellite may communicate therefore varies as a function of time.

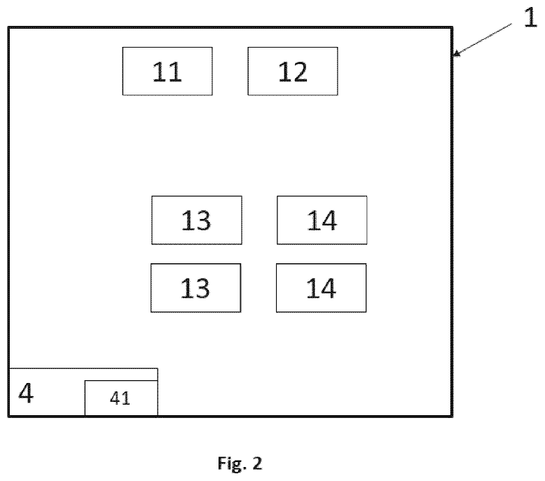

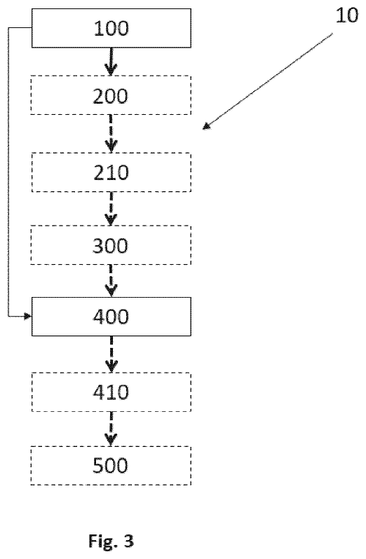

With reference to FIG. 2, an LEO satellite 1 comprises a computer 4 and a memory 41. The computer 4 may for example be a processor or a microcontroller. It has access to the memory 41 so that it may use the information it contains. The computer 4 is configured to execute code instructions allowing a method to be implemented. In particular, the computer 4 is especially configured to execute code instructions allowing a method for controlling a satellite, for example an LEO satellite, one example of which will be presented with reference to FIG. 3, to be implemented.

The memory 41 may for example comprise a read-only memory (ROM), a random-access memory (RAM), an electrically erasable programmable read-only memory (EEPROM) or any other suitable type of storage means in particular allowing code instructions to be read. The memory may for example comprise optical, electronic or even magnetic storage means. The memory 41 may for example comprise code instructions for implementing any one of the methods for controlling a satellite described in the present disclosure.

The LEO satellite 1 comprises a global data transmitter module 11 configured to transmit data to all of the visibility zone Z of the satellite. The global data transmitter module 11 thus comprises a first global-visibility antenna, which covers the entirety of the visibility zone Z of the satellite.

The LEO satellite 1 comprises a global data receiver module 12 configured to receive data from all of the visibility zone Z of the satellite. The global data receiver module 12 thus comprises a second global-visibility antenna, which covers the entirety of the visibility zone Z of the satellite.

In examples, the LEO satellite comprises a global transceiver module comprising a global data transmitter module 11 and a global data receiver module 12 sharing the same global-visibility antenna associated with the visibility zone Z of the satellite.

The LEO satellite 1 also comprises a plurality of local data transmitter modules 13. Each local data transmitter module 13 is configured to transmit data in a respective sub-zone of the visibility zone. In the example shown, the LEO satellite 1 comprises two local data transmitter modules 13, but it may of course comprise more thereof. In examples, the LEO satellite may comprise at least six local data transmitter modules 13.

In examples, the plurality of local data transmitter modules 13 is defined so that the visibility zone covered by the sum of each of the sub-zones associated with the plurality of local transmitter modules 13 represents at least 90% of the visibility zone Z covered by the global transmitter module 11. It is also envisioned to have several sub-pluralities of local data transmitter modules 13 among the plurality of local data transmitter modules 13 covering a relatively similar visibility zone or visibility sub-zone.

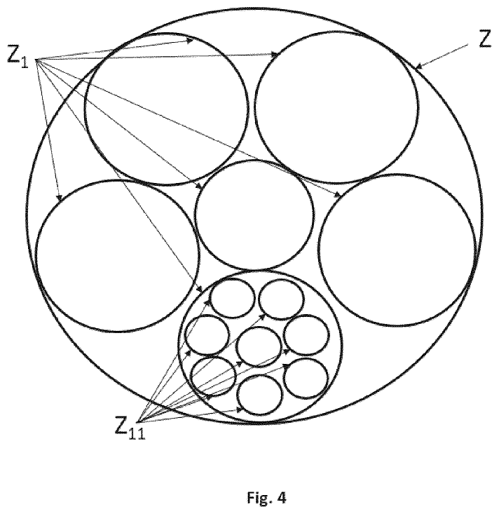

One example is in particular illustrated in FIG. 4, in which the visibility zone Z of the global transmitter module 11 has been shown accompanied by a first plurality of visibility sub-zones Z₁ associated with a first plurality of local transmitter modules 13 and a second plurality of visibility sub-zones Z₁₁ associated with a second plurality of local transmitter modules 13. The second plurality of visibility sub-zones Z₁₁ shown only in one visibility sub-zone Z₁ may of course be extended to all of the visibility zone Z or to all of the visibility sub-zones Z₁ of the first plurality of visibility sub-zones, so that several visibility sub-zones associated with pluralities of local transmitter modules 13 transmitting different data overlap. The satellite may thus be equipped with pluralities of local data transmitter modules defining several sizes of coverage of the visibility zone Z associated with the global data transmitter module 11.

The LEO satellite 1 further comprises a plurality of local data receiver modules 14. Each local data receiver module 14 is configured to receive data from one respective sub-zone of the visibility zone Z. In the example shown, the LEO satellite 1 comprises two local data receiver modules 14, but it may of course comprise more thereof. In examples, the LEO satellite may comprise at least six local data receiver modules 14.

In examples, the plurality of local data receiver modules 14 is defined so that the visibility zone covered by the sum of each of the sub-zones associated with the plurality of local receiver modules 14 represents at least 90% of the visibility zone Z covered by the global receiver module 12. It is also envisioned to have several sub-pluralities of local data receiver modules 14 among the plurality of local data receiver modules 12 covering a relatively similar visibility zone or visibility sub-zone.

One example is in particular illustrated in FIG. 4, in which the visibility zone Z of the global receiver module 11 has been shown accompanied by a first plurality of visibility sub-zones Z₁ associated with a first plurality of local receiver modules 14 and a second plurality of visibility sub-zones Z₁₁ associated with a second plurality of local receiver modules 14. In this case, the description of FIG. 4 in respect of the data transmitter modules also applies to the receiver modules. Thus, the satellite may be equipped with pluralities of local data receiver modules 14 defining several sizes of coverage of the visibility zone Z associated with the global data receiver module 12.

In examples, the LEO satellite comprises a plurality of local data transceiver modules. Each local data transceiver module comprises a local data transmitter module 13 and a local data receiver module 14 sharing the same local-visibility antenna associated with one visibility sub-zone.

Thus, in one example in which a transmitter module and a receiver module are associated with the same antenna in a transceiver module, irrespectively of whether it is a global transceiver module or a local transceiver module, the visibility zone Z or the associated visibility sub-zone is the same for the transmitter module and receiver module.

Moreover, a data transmitter module, irrespectively of whether it is a global data transmitter module 11 or a local data transmitter module 13, may comprise, in addition to its antenna, a power amplifier allowing the power of the signal to be transmitted to vehicles in the visibility zone associated with the antenna to be amplified.

A data receiver module, irrespectively of whether it is a global data receiver module 12 or a local data receiver module 14, may further comprise, in addition to its antenna, a low-noise amplifier (LNA) allowing the power of the signals received by the antenna of the receiver module from the visibility zone associated with said antenna of the module to be amplified.

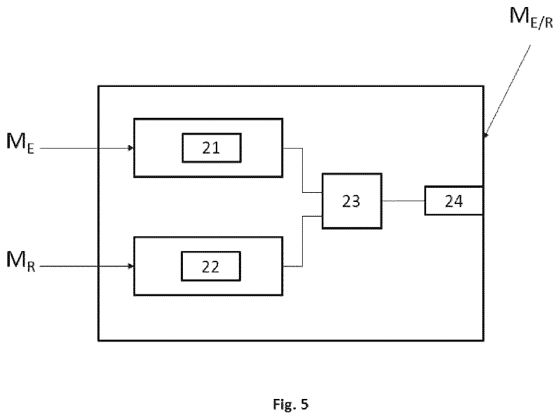

In examples where the satellite comprises a data transceiver module sharing a common antenna, irrespectively of whether it is a global transceiver module or a local transceiver module, this transceiver module may also comprise a device allowing the transmit/receive channels to be combined or separated and optionally allowing the received signals to be filtered. The device may for example be a duplexer. One example of such a transceiver module M_{E/R} is shown in FIG. 5. In particular, the transceiver module M_{E/R} shown in FIG. 5 comprises:
a data transmitter module M_{E} comprising a power amplifier 21,
a data receiver module M_{R} comprising a low-noise amplifier 22,
a duplexer 23, and
an antenna 24.

The satellite moreover comprises a device for activating/deactivating the data transmitter and receiver modules. The activating/deactivating device makes it possible to activate/deactivate the local data transmitter modules 13 and global data transmitter module 11 and the local receiver modules 14 and global receiver module 12 described above. The activating/deactivating device may for example correspond to the computer 4, which would for example be configured to execute code instructions allowing the data transmitter and receiver modules to be activated and/or deactivated.

Activation of a module, irrespectively of whether it is a transmitter or receiver module, designates the act of supplying power thereto, and hence when a module is activated it consumes power available in the satellite and more specifically from its battery. In contrast, when a module is deactivated, the battery no longer supplies this module with power, and hence energy is saved in the satellite.

With reference to FIG. 3, one example of a method 10 for controlling a satellite 1 configured to exchange data with a plurality of vehicles 2 positioned in the visibility zone Z of the satellite will now be described. FIG. 3 schematically shows sequential performance of blocks 100 to 500, but this sequential performance is merely one possible example of execution of the method for controlling the satellite 1. Thus, the blocks of the method shown in FIG. 3 may be executed at different frequencies. In examples, certain blocks may not be executed. It is for example a question of the dotted blocks, which represent discretionary options that are advantageously implemented in the control method.

As illustrated by block 100, the method 10 comprises estimating a number of vehicles present in the visibility zone Z of the satellite that are eligible for a specific service using the global data receiver module 12. In this respect, it is assumed that the vehicles 2 present in the visibility zone transmit presence signals comprising a particular signature to the satellite 1.

A service may for example be provided by the satellite 1, by a base station 3 or by another satellite. A service is for example associated with a certain category or with a certain type of vehicle. A service may for example correspond to a vehicle security update or to an update of a GPS map of a vehicle. These are of course non-limiting examples of possible services.

The specific service may be a service for which all of the vehicles present in the visibility zone Z are eligible, for example when the specific service corresponds to an alert concerning potentially dangerous weather conditions.

It is a question here of using the global receiver module to receive the various presence signals transmitted by the vehicles 2 in the visibility zone. Insofar as they are simply presence signals transmitted by the vehicles, these signals contain little data (of the order of a few bytes) and are less prone to collisions between signals. In this respect, the global receiver module 14 of the satellite configured to receive messages from the entire visibility zone Z is enough to receive the presence signals of the vehicles, even when the visibility zone contains several million vehicles, there being no need to use other receiver modules, this making it possible to save satellite energy. Examples of presence signals comprising particular vehicle signatures are in particular described in patent application FR2109918, incorporated herein by reference.

The number of vehicles present in the visibility zone may for example be estimated using one of the methods described in patent application FR2109918, in which examples of presence signals comprising particular signatures are described.

In examples, the number of vehicles eligible for a specific service present in the visibility zone Z is estimated from the respective particular signature of the presence signals of the vehicles present in the visibility zone Z received by the satellite. The particular signature of a presence signal of a vehicle for example makes it possible to determine, as indicated in patent application FR2109918, a category for this vehicle, which category may be used by the method to determine whether or not this vehicle is eligible for provision of the specific service. It may also be envisioned to use other methods to determine whether a vehicle present in the visibility zone Z of the satellite is eligible for the specific service.

As illustrated by block 400, the method 10 comprises activating, depending on the estimated number of vehicles eligible for the specific service in the visibility zone Z, the global data receiver module 12 or all or some of the local data receiver modules 14 for reception of data.

This block makes it possible to determine, depending on the estimated number of vehicles eligible for the specific service in the zone, which receiver modules must be activated to allow data to be received from vehicles present in the visibility zone. When it is a question of the global data receiver module 13, only this receiver module may be activated, this allowing satellite energy to be saved. This block may for example be implemented by the device for activating/deactivating the data transmitter and receiver modules of a satellite 1.

In first examples, when a number of vehicles estimated to be eligible for the specific service is greater than a global reception threshold associated with the specific service, the method comprises activating a first plurality of local data receiver modules 14 among the plurality of local receiver modules 14. When the estimated number of vehicles is less than the global reception threshold associated with the specific service, the method comprises activating the global data receiver module 12.

In second examples complementary to the first examples, when a number of vehicles estimated to be eligible for the specific service is greater than a reception coverage threshold associated with the specific service, the method comprises activating a second plurality of local data receiver modules 14. The local receiver modules 14 of the second plurality of local data receiver modules 14 are associated with visibility zones of area smaller than the visibility zones associated with the first plurality of local data receiver modules 14. In these examples, the reception coverage threshold associated with the specific service is greater than the global reception threshold associated with the specific service.

The method 10 therefore chooses to activate a plurality of local receiver modules 14 associated with relatively large visibility areas or chooses to activate the global receiver module 12, this making it possible not only to reduce collisions between the data transmitted from the vehicles 2 to the satellite but also to save the battery of the satellite as the one or more relevant modules are activated depending on the estimated number of vehicles eligible for the specific service in the visibility zone.

In examples and as represented by block 200, the method 10 may optionally comprise activating, depending on the estimated number of vehicles eligible for the specific service in the visibility zone Z, the global data transmitter module 11 or all or some of the local data transmitter modules 13 for transmission of data.

This block makes it possible to determine, depending on the estimated number of vehicles eligible for the specific service in the zone, which transmitter modules must be activated to allow data to be transmitted from the satellite to the vehicles present in the visibility zone. When it is a question of the global data transmitter module 11, only this transmitter module may be activated in order to save satellite energy. This block may for example be implemented by the device for activating/deactivating the data transmitter and receiver modules of a satellite 1.

In first examples, when an estimated number of vehicles is greater than a global transmission threshold associated with the specific service, the method comprises activating a first plurality of local data transmitter modules 13 among the plurality of local transmitter modules 13. When the estimated number of vehicles is less than the global transmission threshold associated with the specific service, the method comprises activating the global data transmitter module 11.

In second examples complementary to the first examples, when an estimated number of vehicles is greater than a transmission coverage threshold associated with the specific service, the method comprises activating a second plurality of local data transmitter modules 13. The local transmitter modules 13 of the second plurality of local data transmitter modules 13 are associated with visibility zones of area smaller than the visibility zones associated with the first plurality of local data transmitter modules 13. In these examples, the transmission coverage threshold associated with the specific service is greater than the global transmission threshold associated with the specific service.

The method 10 therefore chooses to activate a plurality of local transmitter modules 13 associated with relatively large visibility areas or chooses to activate the global transmitter module 11, this making it possible not only to guarantee a bandwidth sufficient to transmit data from the satellite 1 to the vehicles 2 but also to save the battery of the satellite as the one or more relevant modules are activated depending on the estimated number of vehicles in the visibility zone.

It will be noted that there may be an asymmetry between the activated transmitter and receiver modules. In other words, the global transmitter module 11 may be activated to transmit in the visibility zone to all of the vehicles while the global data receiver module 12 may be deactivated and replaced by activating a plurality of local receiver modules 14, in order to receive a large data stream from the vehicles while avoiding collisions. This adaptive management of the data transmitter and receiver modules depending on the estimated number of vehicles makes it possible to preserve quality of service in the exchange of data between the satellite and the vehicles while saving satellite energy via an improvement in how power is managed during exchange of data between vehicles and satellite. Specifically, the way in which power is managed by the method better matches the real power requirements of exchange of data between satellite and vehicles, which in particular depend on the visibility zone being overflown and on the nature of the services to be provided to vehicles in this zone.

In examples, and as represented by block 300, the method 10 may optionally comprise transmitting data from the satellite 1 to the vehicles 2 using the one or more activated transmitter modules. Transmission of data from the satellite 1 to the vehicles may comprise transmission of data packets relating to the specific service.

In examples, and as represented by block 500, the method 10 may optionally comprise receiving data from the vehicles 2 using the one or more activated receiver modules. Reception of data from the vehicles 2 may correspond to reception of data corresponding to acknowledgements of receipt of data packets relating to the specific service sent at the end of block 300.

In examples and as represented by block 210, the method 10 may optionally comprise deactivating, depending on the estimated number of vehicles eligible for the specific service in the visibility zone, the global transmitter module 11 or all or some of the local transmitter modules 13 for transmission of data. This block may for example be implemented by the device for activating/deactivating the data transmitter and receiver modules of a satellite 1.

In examples, and as represented by block 410, the method 10 may optionally comprise deactivating, depending on the estimated number of vehicles eligible for the specific service in the visibility zone, the global receiver module 12 or all or some of the local receiver modules 14 for reception of data. This block may for example be implemented by the device for activating/deactivating the data transmitter and receiver modules of a satellite 1.

The present disclosure also relates to a method for controlling a satellite from a ground station 3 in such a way that a satellite implements any of the methods described above. In this sense, the ground station 3 may also comprise a computer and a memory, the memory comprising code instructions allowing the computer of the ground station 3 to implement the method for controlling the satellite.

The present disclosure also relates to a computer program comprising instructions for implementing any of the methods for controlling a satellite or the method for controlling a satellite by means of the ground station 3 when this program is executed by a processor.

Lastly, the present disclosure relates to a computer-readable non-transient storage medium on which is stored a program for implementing any of the methods for controlling a satellite or the method for controlling a satellite by means of the ground station 3 when this program is executed by a processor.

1. A method for controlling a satellite configured to exchange data with a plurality of vehicles positioned in a visibility zone of the satellite, the satellite comprising:
a global data transmitter module configured to transmit data to all of the visibility zone,
a global data receiver module configured to receive data from all of the visibility zone,
a plurality of local data transmitter modules, each local data transmitter module being configured to transmit data in a respective sub-zone of the visibility zone,
a plurality of local data receiver modules, each local data receiver module being configured to receive data from a respective sub-zone of the visibility zone, and the method comprising:
estimating a number of vehicles eligible for a specific service present in the visibility zone using the global data receiver module, and
activating, depending on the estimated number of vehicles eligible for the specific service in the visibility zone, the global data receiver module or all or some of the local data receiver modules for reception of data.

2. The method as claimed in claim 1, wherein the method further comprises:
activating, depending on the estimated number of vehicles eligible for the specific service in the visibility zone, the global data transmitter module or all or some of the local data transmitter modules for transmission of data.

3. The method as claimed in claim 2, wherein the method further comprises:
transmitting data from the satellite to the vehicles using the one or more activated transmitter modules.

4. The method as claimed in claim 2, wherein the method further comprises:
deactivating, depending on the estimated number of vehicles eligible for the specific service in the visibility zone, the global transmitter module or all or some of the local transmitter modules for transmission of data.

5. The method as claimed in claim 1, wherein the method further comprises:
receiving data from the vehicles using the one or more activated receiver modules.

6. The method as claimed in claim 1, wherein the method further comprises:
deactivating, depending on the estimated number of vehicles eligible for the specific service in the visibility zone, the global receiver module or all or some of the local receiver modules for reception of data.

7. A method for controlling a satellite from a ground station in such a way that a satellite implements a method as claimed in claim 1.

8. A device for activating/deactivating data transmitter and receiver modules of a satellite configured to be embedded in a satellite, the satellite comprising:
a global data transmitter module configured to transmit data to all of a visibility zone of the satellite,
a global data receiver module configured to receive data from all of the visibility zone,
a plurality of local data transmitter modules, each local data transmitter module being configured to transmit data in a respective sub-zone of the visibility zone,
a plurality of local data receiver modules, each local data receiver module being configured to receive data from a respective sub-zone of the visibility zone, wherein the device is configured to:
activate, depending on an estimated number of vehicles eligible for the specific service in the visibility zone, the global data receiver module or all or some of the local data receiver modules for reception of data,
deactivate, depending on the estimated number of vehicles eligible for the specific service in the visibility zone, the global data receiver module or all or some of the local data receiver modules for reception of data.

9. The activating/deactivating device as claimed in claim 8, wherein the device is also configured to:
activate, depending on the estimated number of vehicles eligible for a specific service in the visibility zone, the global data transmitter module or all or some of the local data transmitter modules for transmission of data,
deactivate, depending on the estimated number of vehicles eligible for the specific service in the visibility zone, the global data transmitter module or all or some of the local data transmitter modules for transmission of data.

10. A low-earth-orbit satellite into which is embedded an activating/deactivating device as claimed in claim 9.

11. The method as claimed in claim 3, wherein the method further comprises deactivating, depending on the estimated number of vehicles eligible for the specific service in the visibility zone, the global transmitter module or all or some of the local transmitter modules for transmission of data.
